(19) United States
(12) Patent Application Publication
(10) Pub. No.: US 2026/0307642 A1
(43) Pub. Date: Oct. 8, 2026

(54) DYNAMIC CONSTRAINT TECHNIQUES TO MANAGE COMPENSATORY TORQUE REQUESTS IN AN ELECTRIFIED POWERTRAIN

(71) Applicant: FCA US LLC, Auburn Hills, MI (US)

(72) Inventors: McKenzie Walsh, Auburn Hills, MI (US); Gokul Maharaj Badrinath, Auburn Hills, MI (US); Sezai Osman Oder, Auburn Hills, MI (US)

(21) Appl. No.: 19/171,455

(22) Filed: Apr. 7, 2025

(51) Int. Cl. B60W 10/08; B60W 50/00

(52) U.S. Cl. CPC B60W 10/08; B60W 50/00; B60W 2050/0083; B60W 2510/083

(57) ABSTRACT

An electrified vehicle torque calibration and control method includes obtaining a torque command map defining torque commands for first and second electric motors based on varying driver torque demand for the electrified powertrain and varying compensatory torque system requests, generating and outputting, for each torque command, a two-dimensional (2D) donut space plot illustrating the torque command relative to the driver torque demand, motor torque limits of the first and second electric motors, and battery power limits of the battery system, for each torque command that exceeds at least one of the motor torque limits and the battery power limits, receiving, from a calibration engineer, an adjustment to the torque command such that it satisfies both the motor torque limits and the battery power limits while honoring the compensatory torque requests, and generating and outputting a modified torque command map based on the torque command map and the received adjustments.

### FIELD

The present application generally relates to electrified vehicles and, more particularly, to dynamic constraint techniques to manage compensatory torque requests in an electrified powertrain.

### BACKGROUND

Some electrified vehicles have electrified powertrains including two or more electric motors and various hardware limits (motor limits, battery limits, clutch limits, etc.). The method for determining open-loop motor torque commands relative to these hardware limits is also commonly known as “donut space” optimization. The donut space optimization refers to a two-dimensional (2D) plane that represents the mathematical formulation of battery power (represented by inner and outer circles, which is similar to the shape of a donut) and motor torques. In some electrified vehicles, compensatory torques can be added on top of primary open-loop motor torque commands, which could cause the motors to violate the battery power and/or motor torque constraints. Failure to adjust/reduce these excessive open-loop motor torque commands could cause noise/vibration/harshness (NVH) that could be noticeable to a driver. Accordingly, while such conventional electrified vehicle torque control systems do work for their intended purpose, there exists an opportunity for improvement in the relevant art.

### SUMMARY

According to one example aspect of the invention, a torque calibration and control system for an electrified vehicle is presented. In one exemplary implementation, the torque calibration and control system comprises an electrified powertrain of the electrified vehicle, the electrified powertrain including at least a first electric motor and a second electric motor powered by a battery system, a set of compensatory systems of the electrified vehicle that provide compensatory torque requests for the electrified powertrain, and a calibration system configured to obtain a torque command map defining torque commands for the first and second electric motors based on varying driver torque demand for the electrified powertrain and varying compensatory torque requests, generate and output, for each torque command of the torque command map, a two-dimensional (2D) donut space plot illustrating the torque command relative to the driver torque demand, motor torque limits of the first and second electric motors, and battery power limits of the battery system, for each torque command that exceeds at least one of the motor torque limits and the battery power limits, receive, from calibration engineer, an adjustment to the torque command such that it satisfies both the motor torque limits and the battery power limits while honoring the compensatory torque requests, and generate and output a modified torque command map based on the torque command map and the received adjustments.

In some implementations, the calibration engineer selects from one of three predefined options for adjusting the torque command. In some implementations, the three predefined options include (i) following the torque command for the first electric motor, (ii) following the torque command for the second electric motor, and (iii) following the driver torque demand. In some implementations, following the torque command for the first electric motor involves the calibration engineer maintaining an x-coordinate of the torque command on the 2D donut space plot and adjusting a y-coordinate of the torque command on the 2D donut space plot to satisfy both the motor torque limits and the battery power limits, wherein the x-coordinate and γ-coordinate correspond to the torque command for the first electric motor and the second electric motor, respectively. In some implementations, following the torque command for the second electric motor involves the calibration engineer maintaining the y-coordinate of the torque command on the 2D donut space plot and adjusting the x-coordinate of the torque command on the 2D donut space plot to satisfy both the motor torque limits and the battery power limits.

In some implementations, the adjustment by the calibration engineer involves the calibration engineer selecting a possible torque command nearest to the torque command such that the selected possible torque command satisfies both the motor torque limits and the battery power limits. In some implementations, the set of compensatory systems includes an active electric motor damping (AEMD) system. In some implementations, the set of compensatory systems further includes at least one of a wheel end disconnect (WED) or clutch wiggle torque system and an engine pulse cancellation system. In some implementations, the adjustments received from the calibration engineer indicate a priority order of the plurality of compensatory systems. In some implementations, the calibration system is configured to upload the modified torque command map to a control system of the electrified vehicle, and the control system is configured to store the modified torque command map at a memory and utilize the modified torque command map to control the first and second electric motors of the electrified powertrain during operation of the electrified vehicle.

According to another example aspect of the invention, a torque calibration and control method for an electrified vehicle is presented. In one exemplary implementation, the torque calibration and control method comprises providing an electrified powertrain of the electrified vehicle, the electrified powertrain including at least a first electric motor and a second electric motor powered by a battery system, providing a set of compensatory systems of the electrified vehicle that provide compensatory torque requests for the electrified powertrain, obtaining, by a calibration system, a torque command map defining torque commands for the first and second electric motors based on varying driver torque demand for the electrified powertrain and varying compensatory torque requests, generating and outputting, by the calibration system and for each torque command of the torque command map, a two-dimensional (2D) donut space plot illustrating the torque command relative to the driver torque demand, motor torque limits of the first and second electric motors, and battery power limits of the battery system, for each torque command that exceeds at least one of the motor torque limits and the battery power limits, receiving, by the calibration system and from a calibration engineer, an adjustment to the torque command such that it satisfies both the motor torque limits and the battery power limits while honoring the compensatory torque requests, and generating and outputting, by the calibration system, a modified torque command map based on the torque command map and the received adjustments.

In some implementations, the calibration engineer selects from one of three predefined options for adjusting the torque command. In some implementations, the three predefined options include (i) following the torque command for the first electric motor, (ii) following the torque command for the second electric motor, and (iii) following the driver torque demand. In some implementations, following the torque command for the first electric motor involves the calibration engineer maintaining an x-coordinate of the torque command on the 2D donut space plot and adjusting a y-coordinate of the torque command on the 2D donut space plot to satisfy both the motor torque limits and the battery power limits, wherein the x-coordinate and γ-coordinate correspond to the torque command for the first electric motor and the second electric motor, respectively. In some implementations, following the torque command for the second electric motor involves the calibration engineer maintaining the y-coordinate of the torque command on the 2D donut space plot and adjusting the x-coordinate of the torque command on the 2D donut space plot to satisfy both the motor torque limits and the battery power limits.

In some implementations, the adjustment by the calibration engineer involves the calibration engineer selecting a possible torque command nearest to the torque command such that the selected possible torque command satisfies both the motor torque limits and the battery power limits. In some implementations, the set of compensatory systems includes an active electric motor damping (AEMD) system. In some implementations, the set of compensatory systems further includes at least one of a wheel end disconnect (WED) or clutch wiggle torque system and an engine pulse cancellation system. In some implementations, the adjustments received from the calibration engineer indicate a priority order of the plurality of compensatory systems. In some implementations, the torque calibration and control method further comprises uploading, from the calibration system, the modified torque command map to a control system of the electrified vehicle, wherein the control system is configured to store the modified torque command map at a memory and utilize the modified torque command map to control the first and second electric motors of the electrified powertrain during operation of the electrified vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a multi-motor electrified powertrain and an example torque calibration and control system according to the principles of the present application;

FIG. 2 is a flow diagram of an example torque calibration and control method for a multi-motor electrified powertrain of an electrified vehicle according to the principles of the present application; and

FIGS. 3A-3M are plots of example adjustments by a calibration engineer to a motor torque command map using a two-dimensional (2D) donut space representation according to the principles of the present application.

### DESCRIPTION

As previously discussed, some electrified vehicles have electrified powertrains including two or more electric motors and various hardware limits (motor limits, battery limits, clutch limits, etc.). The method for determining open-loop motor torque commands relative to these hardware limits is also commonly known as a “donut space” optimization. The donut space optimization refers to a two-dimensional (2D) plane that represents the mathematical formulation of battery power (represented by inner and outer circles, which is similar to the shape of a donut) and motor torques. In some electrified vehicles, compensatory torques can be added on top of primary open-loop motor torque commands, which could cause the motors to violate the battery power and/or motor torque constraints. Non-limiting examples of these compensatory torques include active electric motor damping (AEMD), wheel-end disconnect (WED) clutch wiggle torque, and engine pulse cancellation. Failure to adjust/reduce these excessive open-loop motor torque commands could cause noise/vibration/harshness (NVH) that could be noticeable to a driver, and could also potentially damage powertrain components and/or cause safety issues.

Accordingly, improved torque calibration and control systems and methods for electrified vehicles having multi-motor electrified powertrains are presented herein. These techniques enable a calibration engineer to determine the best ways to adjust such excessive motor torque commands while still honoring the requested compensatory torque to the maximum possible extent. The calibration engineer can choose from (1) following a Motor A torque command, (2) following a Motor B torque command, or (3) following the driver demand. Based on his/her choice, the final operating point (Motor A and B torque commands) is adjusted from a raw operating point to a nearest valid operating point using a donut space plot. When multiple compensatory torques are being applied, the calibration engineer can also specify an order of importance or priority for each. The adjusted torque commands are then compiled into a modified motor torque command map, which can be uploaded to a vehicle control system and stored at a memory for subsequent use in improved control of the electrified powertrain.

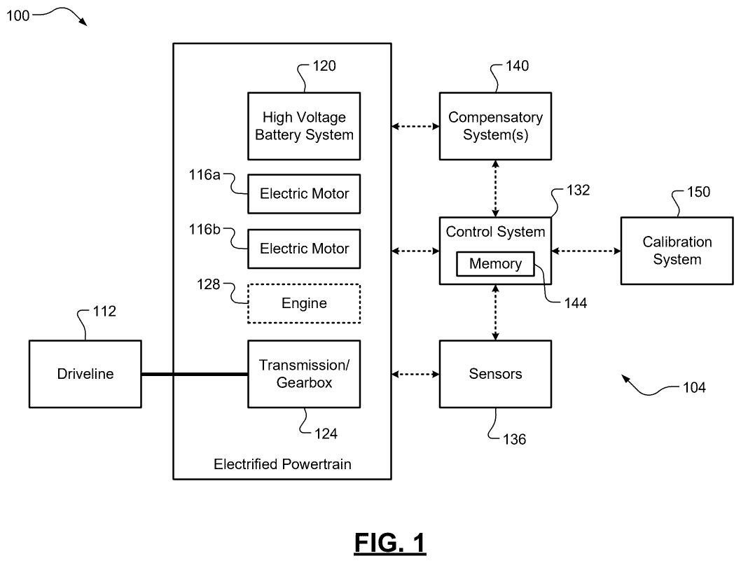

Referring now to FIG. 1, a functional block diagram of an electrified vehicle 100 having an electrified powertrain 108 and an example torque calibration and control system 104 according to the principles of the present application is illustrated. The electrified powertrain 108 is configured to generate and transfer drive torque to a driveline 112 for propulsion of the electrified vehicle 100. The electrified powertrain 108 includes at least two electric motors 116a, 116b (collectively “electric motors 116” and also “Motor A” and “Motor B” herein) that are configured to generate drive torque using electrical energy provided by a high voltage battery pack or system 120. For example, inverters (not shown) could generate phase currents for the respective electric motors 116, which could be, for example only, interior permanent magnet (IPM) synchronous motors (IPMSMs). The drive torque is transferred from the electric motors 116 to the driveline 112 via an optional transmission or gearbox 124. In some embodiments, the electrified powertrain 108 could also include an internal combustion engine 128 (“engine 128”) that is configured to generate additional drive torque and/or to generate mechanical energy for recharging the battery system 120.

A control system 132 is configured to control operation of the electrified vehicle 100, which primarily includes controlling the electrified powertrain 108 to generate a sufficient amount of drive torque to satisfy a driver torque request. The driver torque request could be received from a driver of the electrified vehicle 100 via an accelerator pedal (not shown) and the accelerator pedal position could be monitored by one of a plurality of sensors 136 (“sensors 136”). The sensors 136 could also be configured to monitor or measure other operating parameters including, but not limited to, positions/speeds/accelerations, temperatures, pressures, and electrical parameters (current, voltage, etc.). Some operating parameters, such as a state of charge (SOC) of the battery system 120, could also be modeled based on other measured parameters (e.g., current and voltage). The electrified vehicle 100 also includes one or more compensatory systems 140 (AEMD, WED/clutch wiggle, engine pulse cancellation, etc.) that are configured to generate compensatory motor torque command(s) on top of base open-loop motor torque commands, which can be determined by the control system 132 using a motor torque command map (e.g., a look-up table, or LUT) that is locally stored at a memory 144.

A calibration system 150, which could include a computing system and one or more calibration sensors (e.g., similar to sensors 136) is configured such that a human or robotic calibration engineer (not explicitly shown) can adjust or modify a motor torque command map via the techniques of the present application. Once the final adjusted or modified motor torque command map is obtained at the calibration system 150 in response to inputs/adjustments by the calibration engineer, the calibration system 150 can upload the modified motor torque command map to the control system 132, which stores the modified motor torque command map and then uses it for subsequent control of the electrified powertrain 108 (i.e., torque commands for Motor A 116a and Motor B 116b). By utilizing these modified motor torque commands, the compensatory torques are honored to the maximum extent possible while avoiding exceeding the hardware limits of the electrified powertrain 108. By not exceeding these hardware limits, NVH of the electrified vehicle 100 could potentially be reduced and potential component damage and/or safety issues could potentially be avoided.

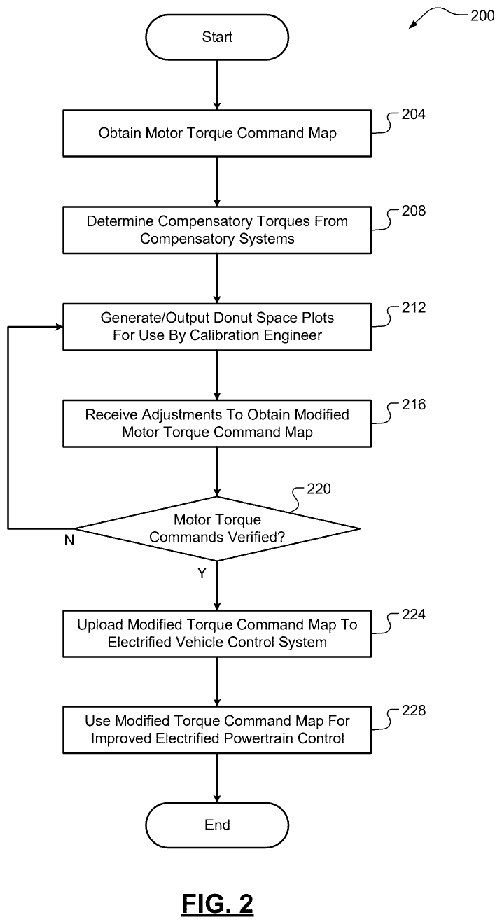

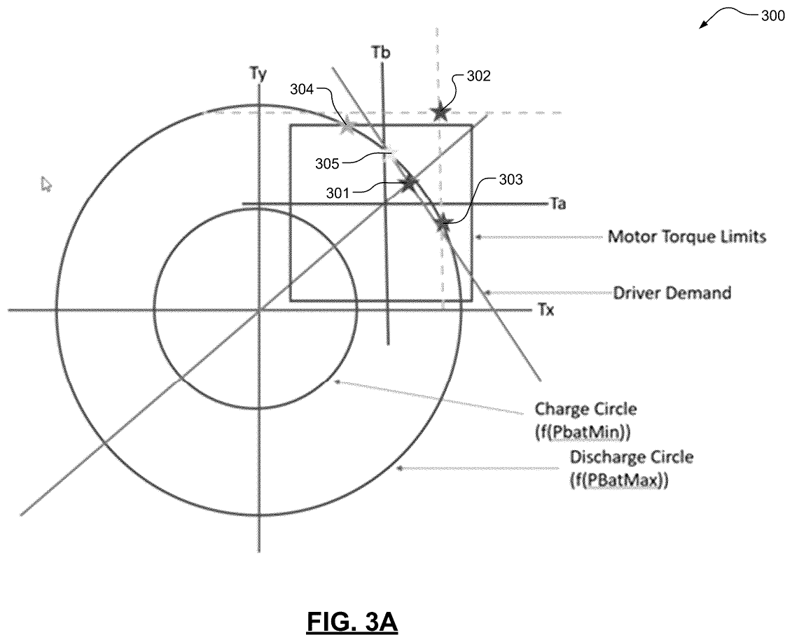

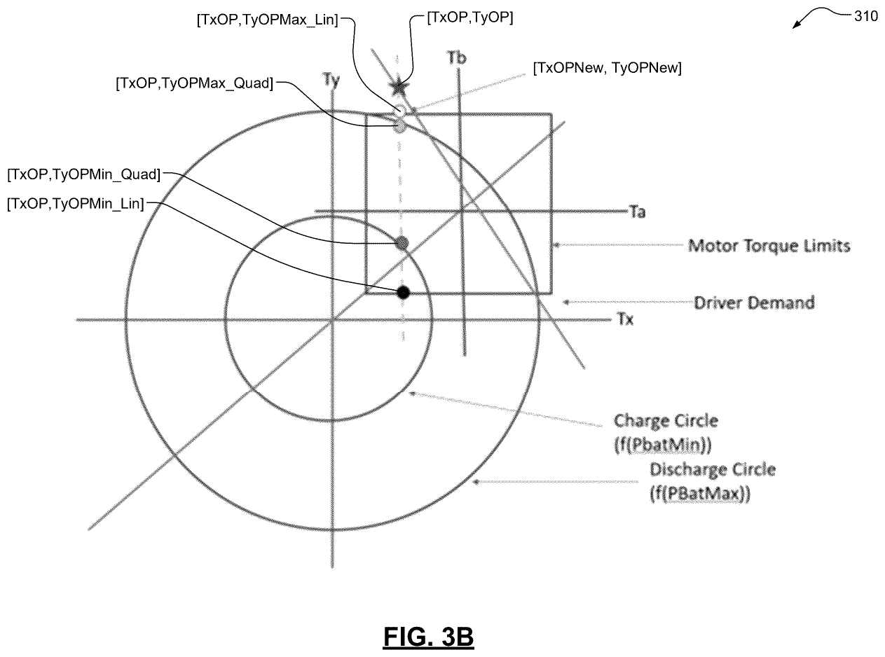

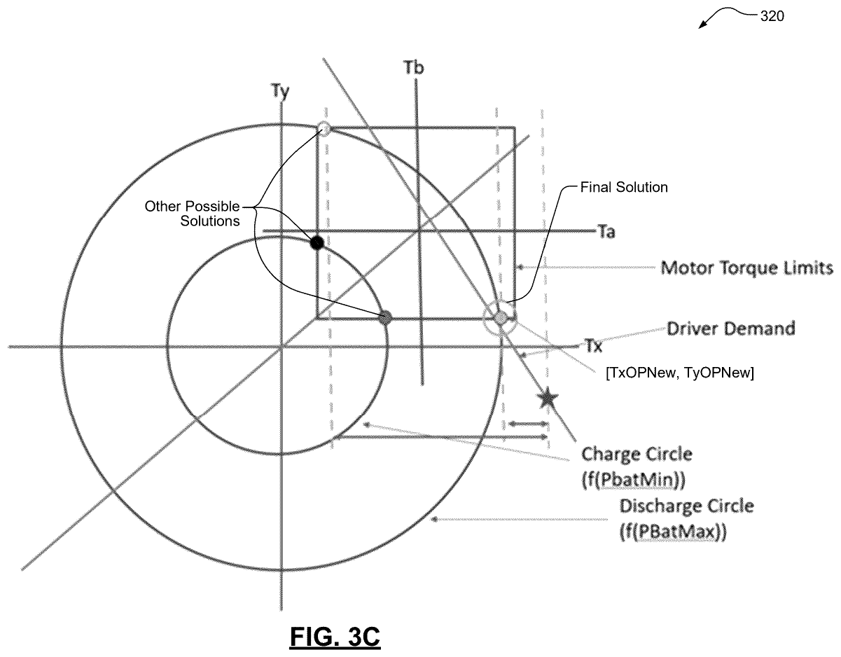

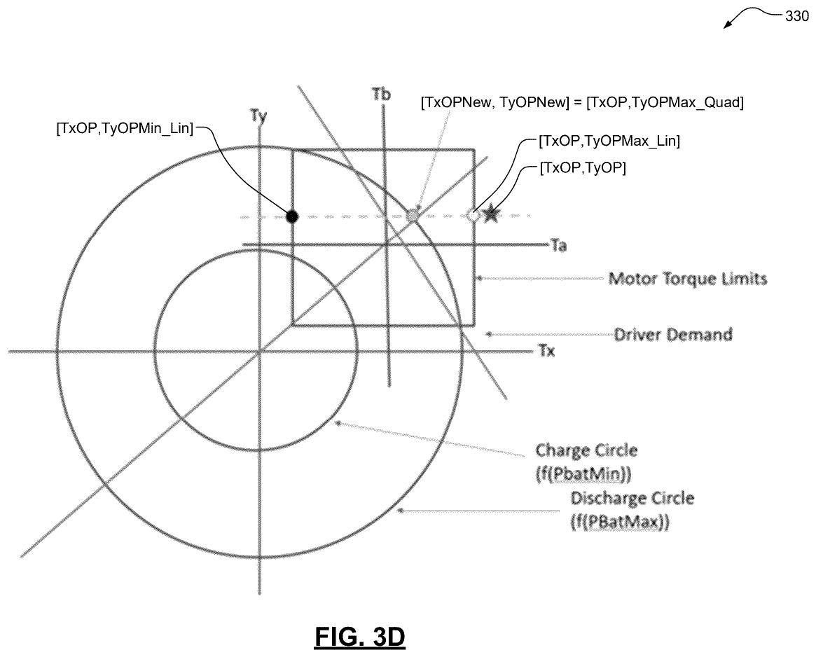

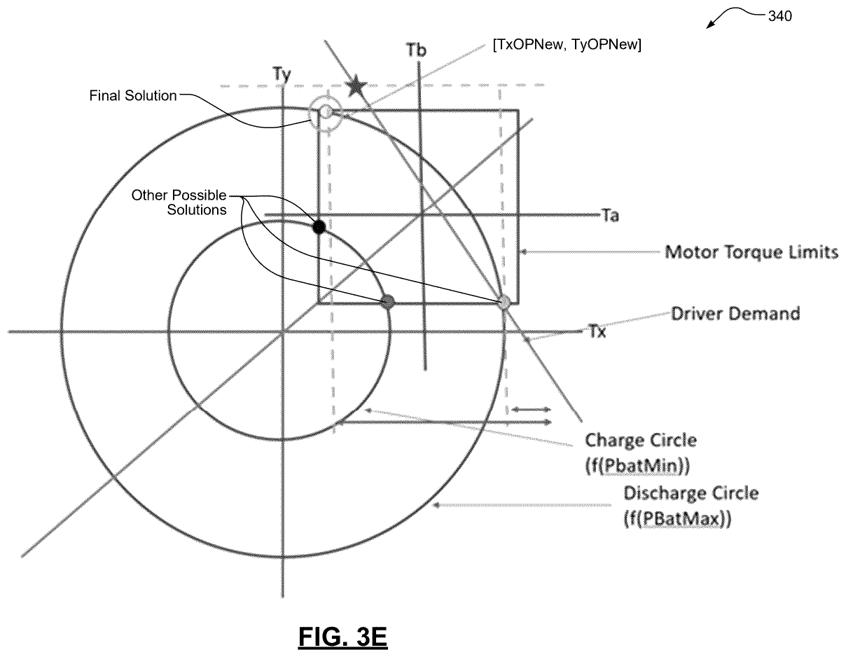

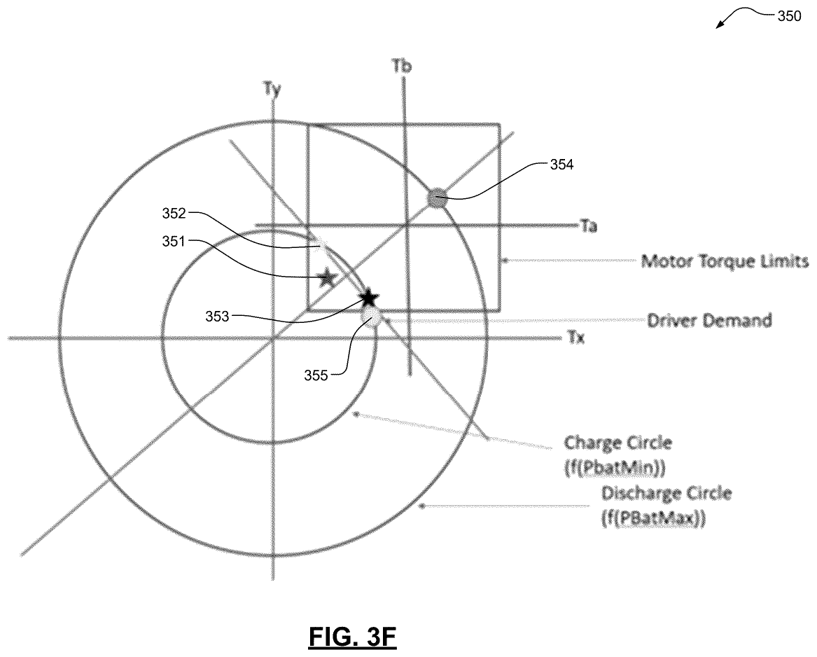

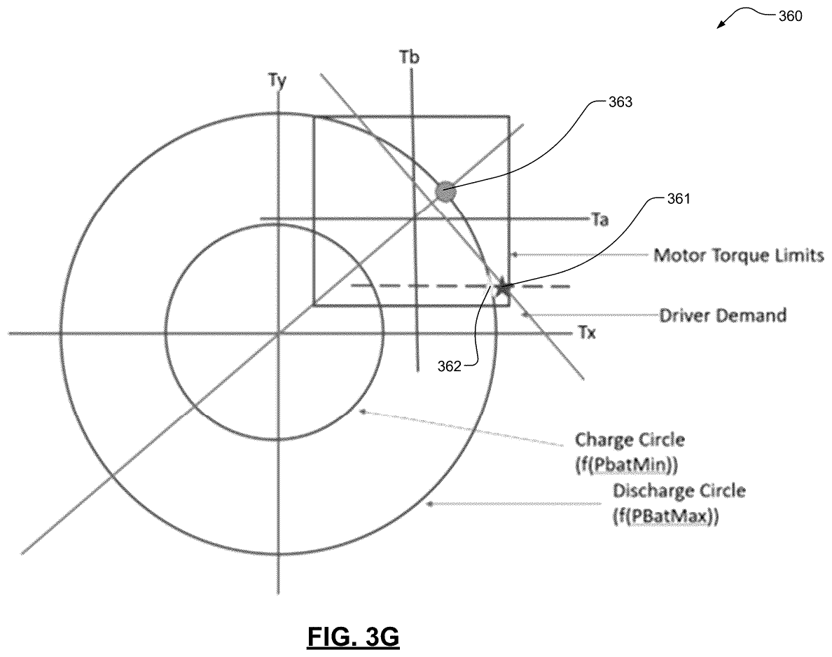

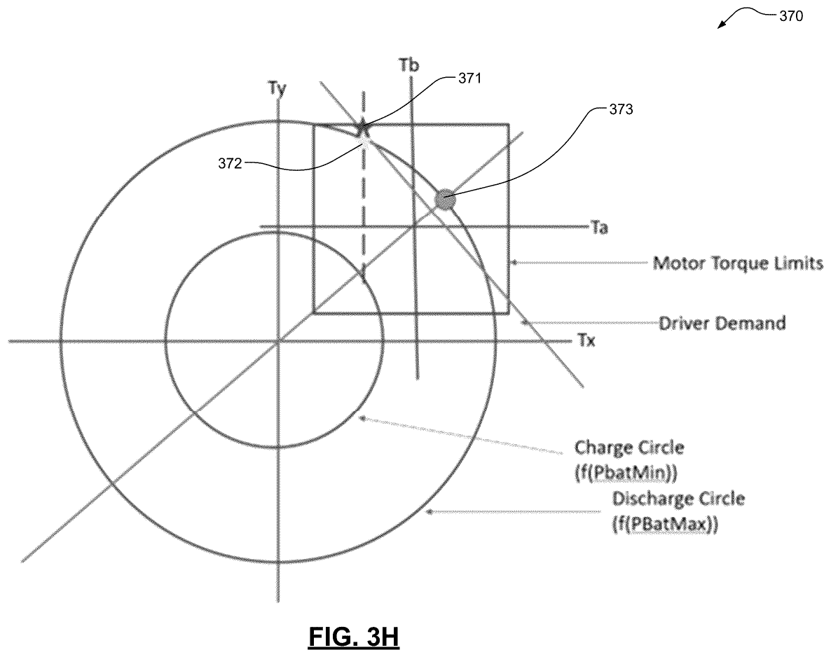

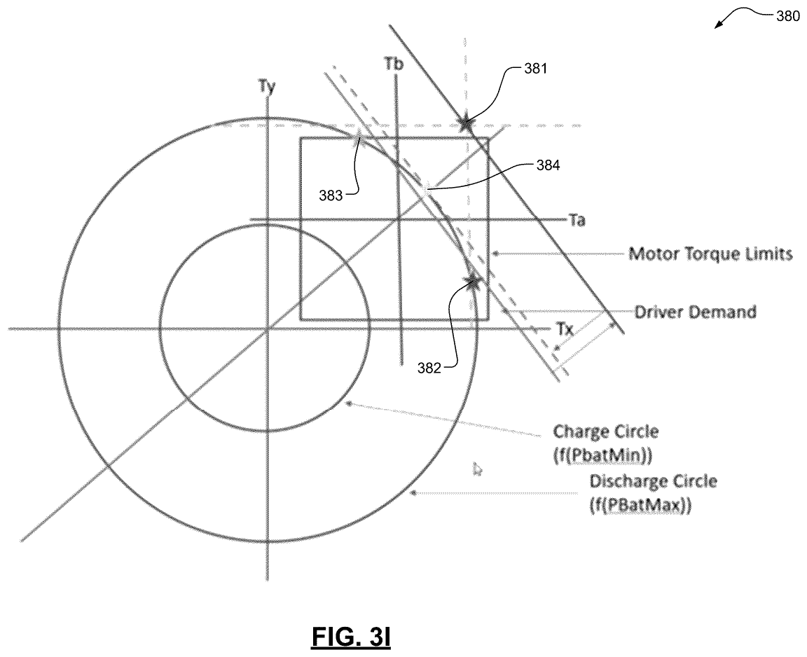

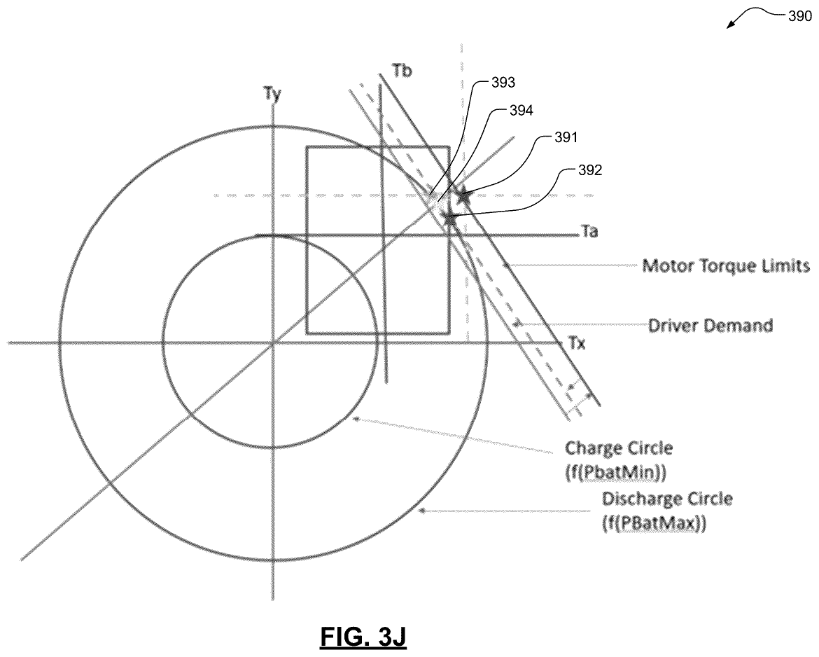

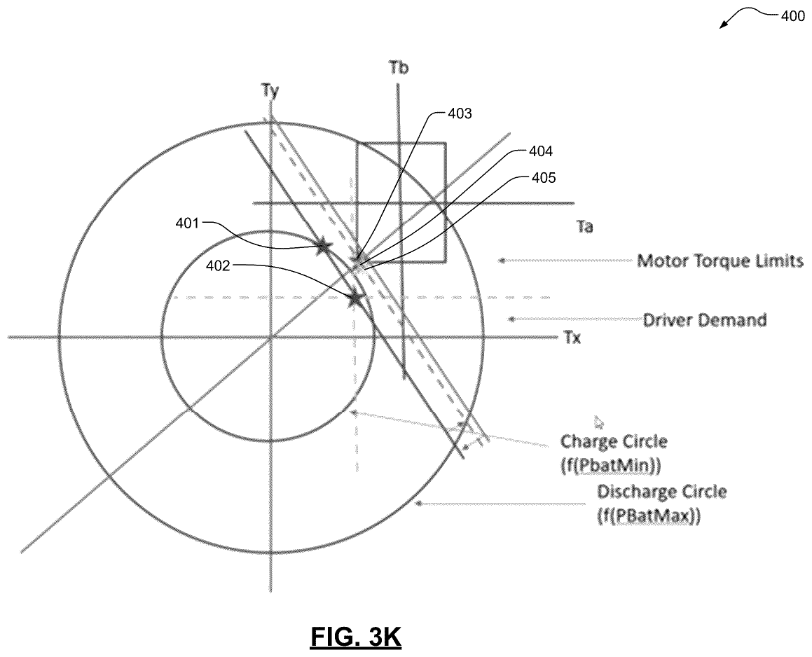

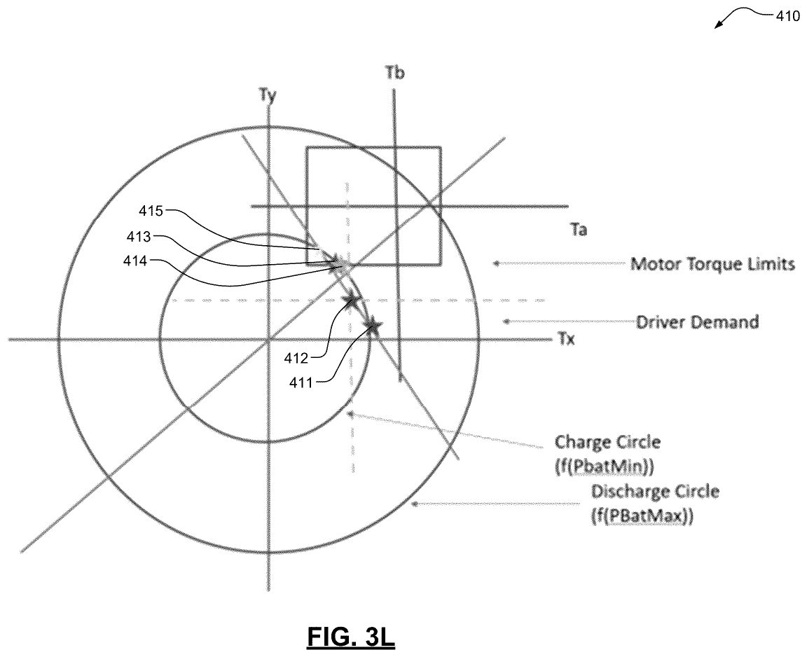

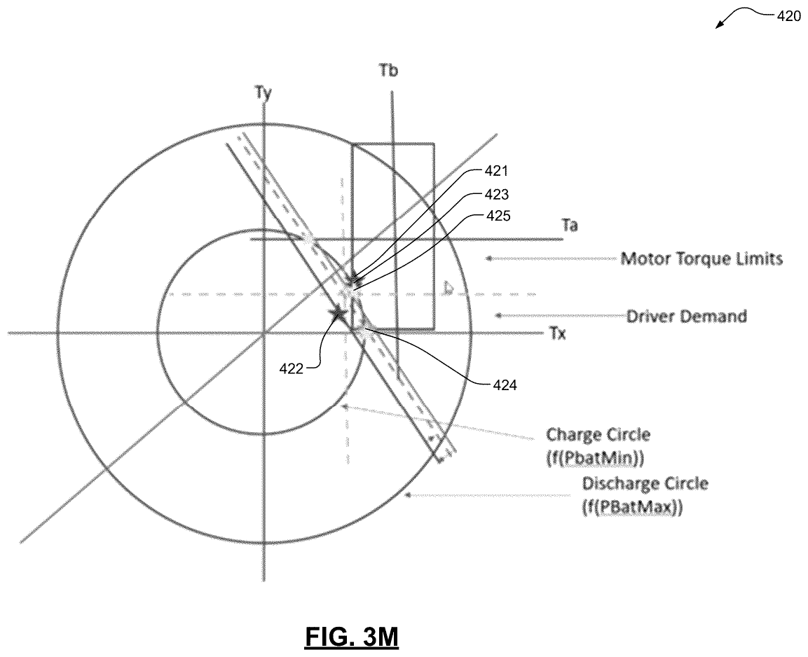

Referring now to FIG. 2 and with continued reference to FIG. 1, a flow diagram of an example torque calibration and control method 200 for a multi-motor electrified powertrain of an electrified vehicle according to the principles of the present application is illustrated. While the method 200 specifically references the electrified vehicle 100 and its components, it will be appreciated that the method 200 could be applicable to any suitably configured electrified vehicle having at least two electric motors. The electrified powertrain 108 could have, for example, a minimum of two electric motors 116 up to a maximum of three electric motors 116 plus the engine 128. The method 200 begins at 204 where the calibration system 150 obtains a motor torque command map. This could be a base or default motor torque command map that does not include any adjustments or calibrations for compensatory system(s) 140. At 208, the calibration system 150 determines compensatory torques from the compensatory system(s) 140. At 212, the calibration system 150 generates and outputs (e.g., displays) 2D donut space plots or representations of the motor torque command map and the compensatory torques for use by a calibration engineer (see, e.g., FIGS. 3A-3M). At 216, the calibration system 150 receives, from the calibration engineer, adjustments to obtain a modified motor torque command map.

This process involves the calibration engineer (e.g., a human user) providing inputs to select or identify which of one or more possible torque commands, each of which satisfies the system constraints, should be used in cases where the compensatory torque(s) cause the motor torque command to exceed these system constraints. These system constraints are discussed in greater detail below with respect to FIGS. 3A-3M. At optional 220, the calibration system 150 could validate the motor torque commands selected or identified by the calibration engineer. This could include, for example, verifying that the motor torque commands do not exceed the system constraints or limits. When validated, the method 200 proceeds to 224. Otherwise, the method 200 could return to 212 or 216 and the calibration engineer could be instructed to select or identify different motor torque commands. It will be appreciated that this step 220 could be optional as the system could only identify valid motor torque commands as options for selection by the calibration engineer. At 224, the calibration system 150 uploads the modified torque command map (including the selected torque commands by the calibration engineer) to the control system 132 of the electrified vehicle. At 228, the control system 132 stores the modified torque command map at its local memory 144 and utilizes the modified torque command map for improved torque control of the electric motors 116 (e.g., reduced NVH while maximizing compensatory torque as much as possible). The method 200 then ends.

Referring now to FIGS. 3A-3M and with continued reference to FIGS. 1-2, plots 300-420 of example adjustments by a calibration engineer to a motor torque command map using a 2D donut space representation according to the principles of the present application are illustrated. These plots 300-420 and the selections by the calibration engineer can correspond to steps 212-216 of the method 200 shown in FIG. 2 and described above. To begin, total battery power (P_{BAT}) consumed can be written as:

$${P}_{B A T} = {P}_{A , Elec} + {P}_{B , Elec} + {P}_{D C L o a d} , \qquad ( 1 )$$

where P_{A} and P_{B} represent the electrical powers consumed by Motor A 116a and Motor B 116b, respectively, and P_{DCLoad} represents the electrical power consumed by direct current (DC) or accessory loads. It should also be noted that in operating scenarios where one of the electric motors 116 powers the other, P_{A}, Elec and P_{B}, Elec may cancel each other. The electrical power representation P_{A}, Elec for Motor A 116a can be represented in the 2D donut space as follows:

$${P}_{A , Elec} = {P}_{A , Mech} + {P}_{A , Loss} = {N}_{A} {T}_{A} + {T}_{A}^{2} * {a}_{1} ( {N}_{A} ) + {T}_{A} * {a}_{2} ( {N}_{A} ) + {a}_{3} ( {N}_{A} ) , \qquad ( 2 a )$$

$${P}_{A} = {N}_{A} {T}_{A} , and \qquad ( 2 b )$$

$${P}_{A , Loss} = {T}_{A}^{2} * {a}_{1} ( {N}_{A} ) + {T}_{A} * {a}_{2} ( {N}_{A} ) + {a}_{3} ( {N}_{A} ) , \qquad ( 2 c )$$

where N_{A} represents a shaft speed of Motor A 116a, T_{A} represents a torque of Motor A 116a, P_{A,Mech} represents a mechanical power generated by Motor A 116a, P_{A,Loss} represents power losses of Motor A 116a, and a₁, a₂, and a₃ are coefficients that are each functions of shaft speed N_{A}.

The electrical power representation P_{A,Elec} in the 2D donut space can thus be rewritten as:

$${P}_{A , Elec} = {( {A}_{1} \cdot {T}_{A} + {A}_{2} )}^{2} + {C}_{A} , \qquad ( 2 d )$$

where A₁, A₂, and C_{A} represent calibratable values given as a function of shaft speed N_{A}. The same applies to the electrical power representation (P_{B,Elec}) for Motor B 116b. That is, the electrical power representation P_{B,Elec} for Motor B 116b can be represented in the 2D donut space as follows:

$${P}_{B , Elec} = {P}_{B , Mech} + {P}_{B , Loss} = {N}_{B} {T}_{B} + {T}_{B}^{2} * {b}_{1} ( {N}_{B} ) + {T}_{B} * {b}_{2} ( {N}_{B} ) + {b}_{3} ( {N}_{B} ) , \qquad ( 3 a )$$

$${P}_{B , M e c h} = {N}_{B} {T}_{B} , and \qquad ( 3 b )$$

$${P}_{B , L o s s} = {T}_{B}^{2} * {b}_{1} ( {N}_{B} ) + {T}_{B} * {b}_{2} ( {N}_{B} ) + {b}_{3} ( {N}_{B} ) , \qquad ( 3 c )$$

where N_{B} represents a shaft speed of Motor B 116b, T_{B} represents a torque of Motor B 116b, P_{B,Mech} represents a mechanical power generated by Motor B 116b, P_{B,Loss} represents power losses of Motor B 116b, and b₁, b₂, and b₃ are coefficients that are each functions of shaft speed N_{B}. The electrical power representation P_{B,Elec} in the 2D donut space can thus be rewritten as:

$${P}_{B , Elec} = {( {B}_{1} \cdot {T}_{B} + {B}_{2} )}^{2} + {C}_{B} , \qquad ( 3 d )$$

where B₁, B₂, and C_{B} represent calibratable values given as a function of shaft speed N_{B}. Thus, the total battery power P_{BAT} can be rewritten as follows, which represents an ellipse:

$${P}_{B A T} = {( {A}_{1} {T}_{A} + {A}_{2} )}^{2} + {C}_{A} + {( {B}_{1} {T}_{B} + {B}_{2} )}^{2} + {C}_{B} + {P}_{D C L o a d} . \qquad ( 4 )$$

Next, the motor torque limits T_{A} and T_{B} can be converted to the 2D donut space representation as follows:

$${T}_{x} = {A}_{1} {T}_{A} + {A}_{2} , and \qquad ( 5 a )$$

$${T}_{y} = {B}_{1} {T}_{B} + {B}_{2} . \qquad ( 5 b )$$

The total battery power P_{BAT} can thus be rewritten as:

$${P}_{B A T} = {T}_{x}^{2} + {T}_{y}^{2} + C , \qquad ( 6 a )$$

where:

$$C = {C}_{A} + {C}_{B} + {P}_{D C L o a d} . \qquad ( 6 b )$$

Minimum and maximum battery power limits (P_{BAT,Min} and P_{BAT,Max}) are known by the control system 132. For example, these limits could be provided to a supervisory controller of the control system 132 by a sub-controller associated with the battery system 120 (e.g., a battery management system, or BMS). These battery power limits P_{BAT,Min} and P_{BAT,Max} define the inner and outer circles that define the donut shape of a 2D donut space representation (see, e.g., FIGS. 3A-3M). The units of Tₓ and T_{y}, as well as the units of A₂ and B₂, in the 2D donut space domain are the square root of kilowatts (KW), or \sqrt{kW}=\sqrt{1000*[(kg·m²)/s²}, where kg represents kilograms, m represents meters, and s represents seconds. The units for A₁ and B₁ in the 2D donut space domain are \sqrt{1000/Nms}, where N represents Newtons. Lastly, the units for C_{A} and C_{B} in the 2D donut space domain are kW.

As mentioned above, the minimum and maximum batter power limits P_{BAT, Min} and P_{BAT, Max} can be expressed as circles centered at zero and can be used to define two concentric circles that represent the donut shape (see, e.g., FIGS. 3A-3M). More specifically:

$${P}_{BAT , Min} - C = {T}_{x}^{2} + {T}_{y}^{2} , and \qquad ( 7 a )$$

$${P}_{BAT , Max} - C = {T}_{x}^{2} + {T}_{y}^{2} . \qquad ( 7 b )$$

The inner circle having the smaller radius can also be referred to as the “charge circle” and can be defined as follows:

$${R}_{Min} = \sqrt{{P}_{BAT , Min} - C} = \sqrt{{P}_{BAT , Min} - ( {C}_{a} + {C}_{b} + {P}_{D C L o a d} )} , and \qquad ( 8 a )$$

$$if {P}_{BAT , Min} - C < 0 , then set {R}_{min} = 0 ,$$

where R_{Min} represents the radius of the charge circle. The outer circle having the larger radius can also be referred to as the “discharge circle” and can be defined as follows:

$${R}_{Max} = \sqrt{{P}_{BAT , Max} - C} = \sqrt{{P}_{BAT , Max} - ( {C}_{a} + {C}_{b} + {P}_{D C L o a d} )} , and \qquad ( 8 )$$

$$if {P}_{BAT , Max} - C < 0 , then set {R}_{max} = 0 ,$$

where R_{Max} represents the radius of the discharge circle. The various examples illustrated in the 2D donut space plots 300-420 of FIGS. 3A-3M will now be discussed in greater detail to further explain how the calibration engineer selects motor torque commands that do not exceed the system constraints while also maximizing the compensatory torque as much as possible.

In FIG. 3A, a 2D donut space plot 300 illustrates a scenario where an initial open loop motor torque command 301 lies within the system constraints (i.e., within the motor torque limits box and between the charge/discharge circles), but a final open loop motor torque command 302, after compensatory torque(s) from the compensatory system(s) 340 are applied, violates both the motor torque constraints and the battery constraints. The solution proposed by the present application allows the calibration engineer to choose a point that meets the system constraints, while not compromising the compensatory torque(s) as much as possible. This generally includes the calibration engineer selecting from three options: (1) following the Motor A torque command, (2) following the Motor B torque command, and (3) following the driver demand. This ensures that the compensation goal is met as much as possible while also meeting the system constraints. The driver demand, as previously discussed herein, is provided by the driver of the electrified vehicle 100 via an accelerator pedal (not shown) and its position is measured by an accelerator pedal sensor of the set of sensors 136. The driver demand is shown in the 2D donut space plots as a line (i.e., a linear variation between Tx and Ty).

For the first option (1), where the calibration engineer follows the Motor A torque command, the compensated actuation coordinates are at operating point (OP) [TaOP, TbOP]. The final actuation coordinates can be calculated by the calibration engineer as follows: First, these coordinates are converted to the donut space:

$$T x O P = T a O P * A 1 + A 2 , and \qquad ( 9 a )$$

$$TyOP = T b O P * B 1 + B 2. \qquad ( 9 b )$$

Second, if the Motor A torque (Ta) is to be honored over the Motor B torque (Tb), then the Motor A torque is kept constant and the Motor B torque is calculated along the constant Motor A torque line, subject to the motor and battery constraints. Thus, by following or honoring the Motor A torque, operating point 303 could be selected instead of other valid operating points 304 and 305. In other words, and referencing plot 310 of FIG. 3B:

$${TxOP}_{N e w} = TxOP , and \qquad ( 10 a )$$

$${TyOP}_{N e w} = min ( max ( T y OP , {TyOP}_{Min} ) , TyOP\_Max ) , \qquad ( 10 b )$$

where:

$$TyOP Min = Max ( TyOP {Min}_{Q u a d} , TyOP {Min}_{L i n} ) , and \qquad ( 10 c )$$

$$TyOP Max = Min ( TyOP {Max}_{Q u a d} , TyOP {Max}_{L i n} ) , \qquad ( 10 d )$$

To further explain the above:

$$TyOP {Max}_{Q u a d} = \sqrt{{R}_{D i s c h a r g e}^{2} - {TxOP}_{N e w}^{2}} , \qquad ( 10 e )$$

$$TyOP {Min}_{Q u a d} = \sqrt{( {R}_{C h a r g e}^{2} - {TxOP}_{N e w}^{2} )} , \qquad ( 10 f )$$

$$TyOP {Min}_{L i n} = Max ( clutch limits , vehicle dynamics limits , etc ) , and \qquad ( 10 g )$$

$$TyOP {Max}_{L i n} = Min ( clutch limits , vehicle dyanmics , etc ) . \qquad ( 10 h )$$

### Finally:

$${TaOP}_{N e w} = ( {TxOP}_{N e w} - A 2 ) / A 1 , and \qquad ( 10 i )$$

$${TbOP}_{N e w} = ( {TyOP}_{N e w} - B 2 ) / B 1. \qquad ( 10 j )$$

In the above example, it can be seen that the constant Motor A torque line has a valid intersection with either the charge/discharge circles or the motor torque linear limits. Theoretically, however, there could be scenarios where there are no such valid intersections. In such cases, the point that has the least x-coordinate difference from the raw operating point that satisfies both the motor linear torque limits and the battery power constraints is chosen. Consider the example shown in the plot 320 of FIG. 3C. The intersection of the TyMin line and the discharge circle has an x-coordinate that is closest to the raw operating point. Thus, this intersection point is chosen as the final (new) operating point (labeled “Final Solution” in FIG. 3C and differing from the other “Possible Solutions”).

For the second option (2), where the calibration engineer follows the Motor B torque command, the compensated actuation coordinates are [TaOP, TbOP]. The final actuation coordinates can be calculated by the calibration engineer as follows. First, these coordinates are converted to the donut space as shown in Equation (9a)-(9b) above. Second, if Motor B torque is to be honored over Motor A torque, then Motor B torque is kept constant and Motor A torque is calculated along the constant Motor B torque line, subject to the motor and battery constraints. Thus:

$${TyOP}_{N e w} = TyOP , and \qquad ( 11 a )$$

$${TxOP}_{N e w} = min ( max ( TxOP , {TxOP}_{Min} ) , TxOP\_Max ) , \qquad ( 11 b )$$

where:

$$TcOP Min = Max ( TxOP {Min}_{Q u a d} , TxOP {Min}_{L i n} ) , and \qquad ( 11 c )$$

$$TxOP Max = Min ( TxOP {Max}_{Q u a d} , TxOP {Max}_{L i n} ) . \qquad ( 11 d )$$

and where:

$$TxOP {Max}_{Q u a d} = \sqrt{{R}_{D i s c h a r g e}^{2} - {TyOP}_{N e w}^{2}} , \qquad ( 11 e )$$

$$TxOP {Min}_{Q u a d} = \sqrt{( {R}_{C h a r g e}^{2} - {TyOP}_{N e w}^{2} )} \qquad ( 11 f )$$

$$TxOP {Min}_{L i n} = Max ( clutch limits , vehicle dynamics limits , etc ) , and \qquad ( 11 g )$$

$$TxOP {Max}_{L i n} = Min ( clutch limits , vehicle dyanmics , etc ) . \qquad ( 11 h )$$

Finally:

$${TaOP}_{N e w} = ( {TxOP}_{N e w} - A 2 ) / A 1 , and \qquad ( 11 i )$$

$${TbOP}_{N e w} = ( {TyOP}_{N e w} - B 2 ) / B 1. \qquad ( 11 j )$$

In the example shown in the plot 330 of FIG. 3D, it can be seen that the constant Motor B torque line has a valid intersection with either the charge/discharge circles or the motor torque linear limits. It should also be noted that there is no illustrated point for [TxOP, TyOPMin_Quad] in FIG. 3D as there was no valid intersection, so this possible point is ignored. Theoretically, however, there could be scenarios where there are no such valid intersections. In such cases, and as similarly discussed above, the point that has the least y-coordinate difference from the raw operating point that satisfies both the motor linear torque limits and the battery power constraints is chosen—[TxOP, TyOPMax_Quad]. In the example shown in the plot 340 of FIG. 3E, the intersection of the TxMin line and the discharge circle has the y-coordinate that is the closest to the raw operating point, so that point is chosen as the final (new) operating point (labeled “Final Solution” in FIG. 3E and differing from the other “Possible Solutions”

For the third and final option (3), where the calibration engineer follows the driver demand, the driver demand (To) is represented as follows:

$$T o = Max ( To Min , Min ( To , To Max ) ) , and \qquad ( 12 a )$$

$$To = Ta 2 Tm 1 * {T}_{A} + T b 2 T m 1 * {T}_{B} + M isc , \qquad ( 12 b )$$

where Ta2Tm1 and Tb2Tm1 each represent ratios that are derived from the physics of the driveline (e.g., gear or belt ratios, respectively), and Misc represents a known constant term that is not involved in the optimization problem (e.g., damping and inertia terms for mechanical loss). Next, by substituting the donut space relations for T_{A} and T_{B}, the following is obtained:

$$T o = T a 2 T m 1 * \frac{{T}_{x} - {A}_{2}}{A 1} + T b 2 T m 1 * \frac{{T}_{y} - {B}_{2}}{{B}_{1}} + Misc , and \qquad ( 12 c )$$

$$To = ( \frac{T a 2 T m 1}{{A}_{1}} ) * {T}_{x} + ( \frac{T b 2 T m 1}{{B}_{1}} ) * {T}_{y} + N , \qquad ( 12 d )$$

where:

$$N = M i s c - ( T a 2 T m 1 * \frac{{A}_{2}}{{A}_{1}} ) - ( T b 2 T m 1 * \frac{{B}_{2}}{{B}_{1}} ) . \qquad ( 12 e )$$

By writing the To equation as a slope-intercept line for plotting, the following is obtained:

$$T y = ( \frac{T a 2 T m 1}{T b 2 T m 1} ) * ( \frac{{B}_{1}}{A 1} ) * {T}_{x} + ( N - {T}_{o} ) * \frac{{B}_{1}}{T b 2 T m 1} . \qquad ( 12 f )$$

From here, there are two possible cases to consider: the operating point lies (1) inside the charging circle or (2) outside the discharging circle.

When the raw operating point lies inside of the charging circle, the solution is found by substituting the equation for the charging circle in the To equation (discussed above) to determine [Tx1, Ty1] and [Tx2, Ty2]:

$${R}^{2} = {T}_{x}^{2} + {T}_{y}^{2} , and \qquad ( 13 a )$$

$${T}_{x 1} and {T}_{x 2} = + \sqrt{{R}^{2} - {T}_{y}^{2}} \& - \sqrt{{R}^{2} - {T}_{y}^{2}} . \qquad ( 13 b )$$

Ty1 and Ty2 are then calculated by substituting for Tx1 and Tx2 in the To equation. The final arbitration for the solution is then based on the following qualifying solutions: (1) if both the coordinates are within the motor torque limits, the solution closest to the ToMin quadratic solution point or previous actuation is chosen based on the calibration engineer's choice; (2) if only one of the coordinates lies within the motor torque limits, then that point is chosen as the final solution; and (3) if neither of the coordinates are within the motor torque limits, then the raw operating point is continued to be used without and adjustment or modification. As shown the example of plot 350 of FIG. 3F, for raw operating point 351, operating point 353 is chosen as being one of multiple points 352-354 within the motor torque limits and the closest to the ToMin point. Other possible operating points 354-355 are not applicable as they are outside of the motor or battery limits.

When the raw operating point lies outside of the discharging circle, the solution is found based on the relevant position of the operating point with respect to the ToMax quadratic solution point. If the Tx coordinate of the operating point is less than the Tx coordinate of the ToMax point, then the constant Tx line is used to calculate Ty of the final operating point. This example is also illustrated in the plot 370 of FIG. 3H, where operating point 372 is selected relative to raw operating point 371 and instead of other possible operating point 373. On the other hand, if the Ty coordinate of the operating point is less than the Ty coordinate of the ToMax point, then the constant Ty line is used to calculate the Tx coordinate of the final operating point. This is similar to the previously-described solutions of (i) following the Motor A torque command and (ii) following the Motor B torque command, respectively. This example is also illustrated in the plot 360 of FIG. 3G, where operating point 362 is selected relative to raw operating point 361 and instead of other possible operating point 363.

FIGS. 3I-3M illustrated other example scenarios for illustrative purposes. In the example shown by plot 380 of FIG. 3I, the raw operating point 381 (including compensatory torque) exceeds both the motor and battery limits. Depending on the goal of the calibration engineer, he/she could choose operating point 382 (following the Motor A torque command), operating point 383 (following the Motor B torque command), or operating point 384 (following the driver demand). In the example shown by plot 390 of FIG. 3J, the raw operating point 391 (including compensator torque) exceeds both the motor and battery limits. Depending on the goal of the calibration engineer, he/she could choose operating point 392 (closest to satisfying the Motor A torque command), operating point 393 (closest to satisfying the Motor B torque command), or operating point 394 (closest to satisfying the driver demand).

In the example shown by plot 400 of FIG. 3K, the raw operating point 401 (not including compensatory torque) exceeds the motor torque limits but is not within the charging circle, thus satisfying the battery limits. The raw operating point 402 (including compensatory torque), however, is within the charging circle, thus violating the battery limits. In this example, each of the possible operating points 403-405 from the various methods described herein are approximately the same (i.e., at a bottom left corner of the motor torque limit box). The example shown by plot 410 of FIG. 3L is similar to that of FIG. 3K. The raw operating point 411 (not including compensatory torque) exceeds the motor torque limits but is not within the charging circle, thus satisfying the battery limits. The raw operating point 412 (including compensatory torque), however, is within the charging circle, thus violating the battery limits. In this example, each of the possible operating points 413-415 from the various methods described herein are again approximately the same (i.e., near a bottom left corner of the motor torque limit box). These variations, however, while appearing to be relatively minor, could still significantly factor into the decision by the calibration engineer to maximize the compensatory torque as much as possible.

The example shown by plot 420 of FIG. 3M is again similar to that of FIGS. 3K-3K. The raw operating point 421 (not including compensatory torque) exceeds the motor torque limits but is not within the charging circle, thus satisfying the battery limits. The raw operating point 422 (including compensatory torque), however, is within the charging circle, thus violating the battery limits. In this example, the possible operating points 423-425 vary more than the examples of FIGS. 3J-3K. For example, operating point 424 significantly reduces Motor B torque, which is a goal of the compensatory torque, whereas operating points 423 and 425 increase Motor B torque, which is not a goal of the compensatory torque.

As can be seen, the calibration engineer is allotted a degree of freedom in selecting from multiple operating points that satisfy the motor/battery limits while also still maximizing the compensatory torque goals. In some cases, there could be multiple compensatory systems 140 active at a given time, and in some cases, these compensatory systems 140 could have competing goals. Thus, the calibration engineer could define a priority or order to various compensatory system(s) 140 such that certain ones are prioritized in the motor torque command modifications compared to others. For example only, AEMD (active damping) could be prioritized over engine pulse cancellation if motor vibrations/oscillations are more of a factor to NVH than engine vibrations/oscillations. This priority could vary between different electrified vehicles depending on the configuration of the powertrain/driveline and based on observed NVH characteristics of each electrified vehicle during operation.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A torque calibration and control system for an electrified vehicle, the torque calibration and control system comprising:
an electrified powertrain of the electrified vehicle, the electrified powertrain including at least a first electric motor and a second electric motor powered by a battery system;
a set of compensatory systems of the electrified vehicle that provide compensatory torque requests for the electrified powertrain; and
a calibration system configured to:
obtain a torque command map defining torque commands for the first and second electric motors based on varying driver torque demand for the electrified powertrain and varying compensatory torque requests;
generate and output, for each torque command of the torque command map, a two-dimensional (2D) donut space plot illustrating the torque command relative to the driver torque demand, motor torque limits of the first and second electric motors, and battery power limits of the battery system;
for each torque command that exceeds at least one of the motor torque limits and the battery power limits, receive, from a calibration engineer, an adjustment to the torque command such that it satisfies both the motor torque limits and the battery power limits while honoring the compensatory torque requests; and
generate and output a modified torque command map based on the torque command map and the received adjustments.

2. The torque calibration and control system of claim 1, wherein the calibration engineer selects from one of three predefined options for adjusting the torque command.

3. The torque calibration and control system of claim 2, wherein the three predefined options include (i) following the torque command for the first electric motor, (ii) following the torque command for the second electric motor, and (iii) following the driver torque demand.

4. The torque calibration and control system of claim 3, wherein following the torque command for the first electric motor involves the calibration engineer maintaining an x-coordinate of the torque command on the 2D donut space plot and adjusting a y-coordinate of the torque command on the 2D donut space plot to satisfy both the motor torque limits and the battery power limits, wherein the x-coordinate and γ-coordinate correspond to the torque command for the first electric motor and the second electric motor, respectively.

5. The torque calibration and control system of claim 4, wherein following the torque command for the second electric motor involves the calibration engineer maintaining the y-coordinate of the torque command on the 2D donut space plot and adjusting the x-coordinate of the torque command on the 2D donut space plot to satisfy both the motor torque limits and the battery power limits.

6. The torque calibration and control system of claim 3, wherein the adjustment by the calibration engineer involves the calibration engineer selecting a possible torque command nearest to the torque command such that the selected possible torque command satisfies both the motor torque limits and the battery power limits.

7. The torque calibration and control system of claim 1, wherein the set of compensatory systems includes an active electric motor damping (AEMD) system.

8. The torque calibration and control system of claim 7, wherein the set of compensatory systems further includes at least one of a wheel end disconnect (WED) or clutch wiggle torque system and an engine pulse cancellation system.

9. The torque calibration and control system of claim 8, wherein the adjustments received from the calibration engineer indicate a priority order of the plurality of compensatory systems.

10. The torque calibration and control system of claim 1, wherein the calibration system is configured to upload the modified torque command map to a control system of the electrified vehicle, and wherein the control system is configured to store the modified torque command map at a memory and utilize the modified torque command map to control the first and second electric motors of the electrified powertrain during operation of the electrified vehicle.

11. A torque calibration and control method for an electrified vehicle, the torque calibration and control method comprising:
providing an electrified powertrain of the electrified vehicle, the electrified powertrain including at least a first electric motor and a second electric motor powered by a battery system;
providing a set of compensatory systems of the electrified vehicle that provide compensatory torque requests for the electrified powertrain;
obtaining, by a calibration system, a torque command map defining torque commands for the first and second electric motors based on varying driver torque demand for the electrified powertrain and varying compensatory torque requests;
generating and outputting, by the calibration system and for each torque command of the torque command map, a two-dimensional (2D) donut space plot illustrating the torque command relative to the driver torque demand, motor torque limits of the first and second electric motors, and battery power limits of the battery system;
for each torque command that exceeds at least one of the motor torque limits and the battery power limits, receiving, by the calibration system and from a calibration engineer, an adjustment to the torque command such that it satisfies both the motor torque limits and the battery power limits while honoring the compensatory torque requests; and
generating and outputting, by the calibration system, a modified torque command map based on the torque command map and the received adjustments.

12. The torque calibration and control method of claim 11, wherein the calibration engineer selects from one of three predefined options for adjusting the torque command.

13. The torque calibration and control method of claim 12, wherein the three predefined options include (i) following the torque command for the first electric motor, (ii) following the torque command for the second electric motor, and (iii) following the driver torque demand.

14. The torque calibration and control method of claim 13, wherein following the torque command for the first electric motor involves the calibration engineer maintaining an x-coordinate of the torque command on the 2D donut space plot and adjusting a y-coordinate of the torque command on the 2D donut space plot to satisfy both the motor torque limits and the battery power limits, wherein the x-coordinate and γ-coordinate correspond to the torque command for the first electric motor and the second electric motor, respectively.

15. The torque calibration and control method of claim 14, wherein following the torque command for the second electric motor involves the calibration engineer maintaining the y-coordinate of the torque command on the 2D donut space plot and adjusting the x-coordinate of the torque command on the 2D donut space plot to satisfy both the motor torque limits and the battery power limits.

16. The torque calibration and control method of claim 13, wherein the adjustment by the calibration engineer involves the calibration engineer selecting a possible torque command nearest to the torque command such that the selected possible torque command satisfies both the motor torque limits and the battery power limits.

17. The torque calibration and control method of claim 11, wherein the set of compensatory systems includes an active electric motor damping (AEMD) system.

18. The torque calibration and control method of claim 17, wherein the set of compensatory systems further includes at least one of a wheel end disconnect (WED) or clutch wiggle torque system and an engine pulse cancellation system.

19. The torque calibration and control method of claim 18, wherein the adjustments received from the calibration engineer indicate a priority order of the plurality of compensatory systems.

20. The torque calibration and control method of claim 11, further comprising uploading, from the calibration system, the modified torque command map to a control system of the electrified vehicle, wherein the control system is configured to store the modified torque command map at a memory and utilize the modified torque command map to control the first and second electric motors of the electrified powertrain during operation of the electrified vehicle.
